(19) United States
(12) Patent Application Publication
(10) Pub. No.: US 2014/0093658 A1
(43) Pub. Date: Apr. 3, 2014

(54) METHODS AND SYSTEMS FOR JOINING MATERIALS

(71) Applicant: GENERAL ELECTRIC COMPANY, Schenectady, NY (US)

(72) Inventors: Qi Zhao, Niskayuna, NY (US); Robert John Zabala, Niskayuna, NY (US); Laurent Cretegny, Niskayuna, NY (US); Jeffrey Jon Schoonover, Niskayuna, NY (US); Mark Kevin Meyer, Cincinnati, OH (US); Keith Anthony Lauria, Niskayuna, NY (US); William R. Catlin, Niskayuna, NY (US)

(73) Assignee: General Electric Company, Schenectady, NY (US)

(21) Appl. No.: 13/630,874

(22) Filed: Sep. 28, 2012

(51) Int. Cl. B05D 3/06

(52) U.S. Cl. CPC B05D 3/06
USPC 427/595; 118/620

(57) ABSTRACT

A method is provided for joining a filler material to a substrate material. The method includes melting the filler material within a melting chamber of a crucible such that the filler material is molten, holding the filler material within the melting chamber of the crucible by electromagnetically levitating the filler material within the melting chamber, and releasing the filler material from the melting chamber of the crucible to deliver the filler material to a target site of the substrate material.

### BACKGROUND

Application fatigue may cause various metal, ceramic, and alloy components (e.g., super alloys) to experience wear. For example, cracking, abrasion, erosion, and/or a variety of other conditions may cause the removal or wear of original substrate material. To repair the worn components, filler material may be added (e.g., welded) to fill in cracks, to patch abrasions, and/or to otherwise replace material lost to erosion. Likewise, when joining two or more components together, filler material may be added to the original substrate material of one or more of the components. Filler material that is the same as, or similar to, the substrate material may be used to provide relatively strong uniform mechanical properties across the repaired and/or joined components.

When the filler material is a relatively high temperature performance alloy (e.g., nickel and/or cobalt based super alloys used in relatively hot gas paths of gas turbine engines) that has a relatively high melting temperature, a relatively significant application of energy must be applied to the filler material before the filler material can be applied to the original substrate material. But, the large amount of radiant heat (e.g., produced by a welding apparatus) that is used to melt the filler material may also affect the original substrate material. For example, the impingement of the radiant heat may cause slumping, melting, recrystallization, grain growth, and/or other changes to the microstructure of the original substrate material. Such changes in the original substrate material may reduce the strength, toughness, and/or other mechanical properties of the component(s) being repaired and/or joined together. Moreover, the impingement of the radiant heat on the original substrate material may cause the joint between the filler material and the original substrate material to fracture during cooling, which is commonly referred to as “hot tearing”.

While filler materials with lower melting temperatures may alternatively be used, such filler materials may provide lower performance at high temperatures and/or possess mechanical properties that are increasingly different than the mechanical properties of the original substrate material. For example, a brazing process may impart less heat to the original substrate material. But, the melting point of brazing materials must be lower than the melting point of the original substrate material, which may require the use of melting point suppressing elements (e.g., silicon and/or boron) in quantities that result in the formation of relatively high amounts of brittle intermetallic phases that deleteriously affect the mechanical properties of the repaired and/or joined component(s). What is needed is a technique and system that allow the use of relatively high melting temperature filler material without causing problems with the original substrate material.

### BRIEF DESCRIPTION

In one embodiment, a method is provided for joining a filler material to a substrate material. The method includes melting the filler material within a melting chamber of a crucible such that the filler material is molten, holding the filler material within the melting chamber of the crucible by electromagnetically levitating the filler material within the melting chamber, and releasing the filler material from the melting chamber of the crucible to deliver the filler material to a target site of the substrate material.

In another embodiment, a system is provided for joining a filler material to a substrate material. The system includes a crucible having a melting chamber for holding the filler material. The crucible includes an outlet fluidly connected to the melting chamber. A heating element is operatively connected to the crucible for heating the filler material within the melting chamber of the crucible. The heating element is configured to melt the filler material within the melting chamber such that the filler material is molten. A flow control mechanism is operatively connected to the crucible for controlling flow of the filler material through the outlet of the melting chamber. The flow control mechanism is configured to electromagnetically levitate the filler material within the melting chamber to hold the filler material within the melting chamber.

In another embodiment, a method is provided for joining a filler material to a substrate material. The method includes providing a molten metal filler material within a melting chamber of a crucible, and generating a first magnetic field from a coil that extends around the melting chamber to induce a second magnetic field within the filler material that is opposite the first magnetic field, wherein the opposite first and second magnetic fields hold the filler material within the melting chamber of the crucible. The method also includes releasing the filler material from the melting chamber of the crucible to deliver the filler material to a target site of the substrate material.

### BRIEF DESCRIPTION OF THE DRAWINGS

FIG. 1 is a schematic illustration of an exemplary embodiment of a system for joining a filler material to a substrate material.

FIG. 2 is a cross sectional view of an exemplary embodiment of a nozzle of the system shown in FIG. 1.

FIG. 3 is a perspective view of an exemplary embodiment of an induction coil of the system shown in FIG. 1.

FIG. 4 is a perspective view of another exemplary embodiment of an induction coil of the system shown in FIG. 1.

FIG. 5 is another schematic illustration of the system shown in FIG. 1.

FIG. 6 is a flowchart illustrating an exemplary embodiment of a method for joining a filler material to a substrate material.

### DETAILED DESCRIPTION

The following detailed description of certain embodiments will be better understood when read in conjunction with the appended drawings. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Various embodiments provide methods and systems for joining a filler material to a substrate material. Various embodiments may provide an improvement in the mechanical properties of conventional joining and repair techniques. Various embodiments may include melting the filler material within a melting chamber of a crucible such that the filler material is molten, holding the filler material within the melting chamber of the crucible by electromagnetically levitating the filler material within the melting chamber, and releasing the filler material from the melting chamber of the crucible to deliver the filler material to a target site of the substrate material in a molten stream. The filler material may be melted at a remote distance away from the target site of the substrate material such that the melting of the filler material does not cause the target site of the substrate material to rise above a solidus and/or recrystallization temperature of the target site. The molten filler material may be delivered to the target site of the substrate material in a continuous stream. Various embodiments may provide a flow control mechanism that uses electromagnetic levitation and allows both vacuum and inert gas and/or joining operations.

Technical effects of various embodiments may include reducing or eliminating the use of melting point suppressants in the filler material, reducing the amount of excessive heat imparted on the substrate material, and/or delivering molten filler material for component repairs without filler material contaminations. For example, technical effects of various embodiments may provide relatively clean molten filler material delivery for consecutive component repairs without filler material contaminations and/or for recast repairs without filler material contaminations. Further, technical effects of various embodiments may include melting a filler material (e.g., a super alloy filler material) inside a melting chamber (e.g., of a ceramic crucible) without thermal shock, mechanical failures, and/or melt contaminations (e.g., from the melting chamber). Technical effects of various embodiments may include enabling the repair of components that were previously replaced because no repair techniques were available to restore adequate structure and/or properties of the components. Moreover, technical effects of various embodiments may include enabling alternate manufacturing options for casting relatively high quality sub-components that can then be joined with joints having mechanical properties approaching, similar to, and/or identical to the substrate material.

As used herein, the term “component” may be any type of component having any structure, any size, and any geometry that allows for the application of molten filler material to a target site of a substrate material of the component. For example, the component may include a relatively flat repair surface with a void at the target site. The void may be present from various application fatigues, such as, but not limited to, cracking, rubbing, abrasion, erosion, other conditions that may cause the removal and/or wear of the substrate material of the component, and/or the like. Moreover, in some embodiments, the component includes one or more curves, corners, anus, joints, and/or the like. Examples of components that may be repaired and/or joined using the various embodiments described and/or illustrated herein include, but are not limited to, components fabricated using a casting process, aircraft components, aircraft engine components, gas turbine engine components (e.g., a bucket for a gas turbine engine), airfoils (e.g., a turbine blade for a gas turbine engine), nozzles (e.g., a single crystal nozzle of a gas turbine engine), and/or the like.

The substrate material of the component may include any substance(s) such that the substrate material is capable of having a molten filler material joined (e.g., contacted and subsequently bonded) thereto at one or more locations (i.e., target sites). For example, the substrate material may include, but is not limited to, metals, alloys, ceramics, super alloys, and/or the like. In some embodiments, the substrate material includes a relatively low amount, or no, silicon. In some embodiments, the substrate material includes a nickel-based super alloy, such as, but not limited to, nickel-based super alloys used in gas turbine engines for relatively hot gas path applications, and/or the like. For example, the substrate material may include the commercially available Rene™ N5 alloy. Moreover, in some embodiments, the substrate material includes a cobalt-based super alloy such as, but not limited to, cobalt-based super alloys used in gas turbine engines for relatively hot gas path applications, and/or the like. The target site of the substrate material of the component may be any location(s) where filler material is intended to be added. For example, the target site may include a crack, a joint between multiple components or sub-components, an abrasion, an eroded area, and/or the like.

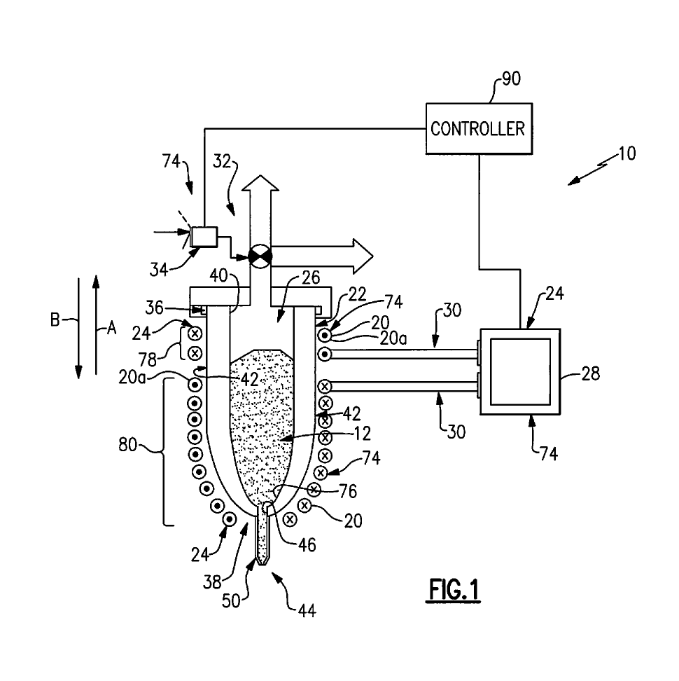

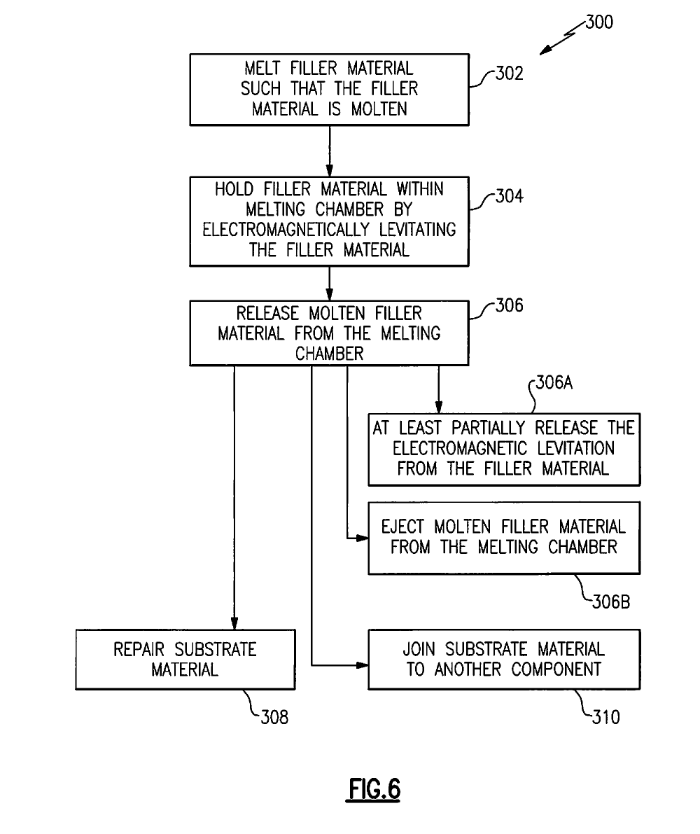

FIG. 1 is a schematic illustration of an exemplary embodiment of a system 10 for joining a filler material 12 to a substrate material 14 (shown in FIG. 5) of a component 16 (shown in FIG. 5) at a target site 18 (shown in FIG. 5) of the substrate material 14. As will be described below, the system 10 may be disposed at a remote distance D_{R} (shown in FIG. 5) away from the target site 18 of the substrate material 14. As used herein, the term “remote distance” includes any distance between the target site 18 and the system 10 (e.g., a heating element 20, a crucible 22, and any molten filler material 12 in the crucible 22) that is large enough such that the target site 18 does not rise above the solidus and/or recrystallization temperature of the target site 18 as a result of the radiant energy from the system 10.

The system 10 includes the crucible 22, a heating unit 24, and a flow control mechanism 74. The heating unit 24 includes the heating element 20. The crucible 22 is configured to hold the filler material 12. Specifically, the crucible 22 includes a melting chamber 26. The melting chamber 26 is configured to hold the filler material 12 therein as the filler material 12 is melted and thereby transformed into a molten state. The melting chamber 26 is configured to at least temporarily hold the molten filler material 12 therein before the molten filler material 12 is delivered to the substrate material 14.

The crucible 22 may include any substance(s) that enables the melting chamber 26 to hold the filler material 12 therein as the filler material 12 is melted and that enables the melting chamber 26 to at least temporarily hold the molten filler material 12 therein. Examples of suitable substances of the crucible 22 include, but are not limited to, oxides, carbides, nitrides, alumina-based ceramics, alumina, porous alumina, boron nitride, quartz, ceramics, refractory ceramics, metallic cold hearths, substances that are susceptible to induction heating, and/or the like. Although shown as having the shape of a conical cylinder, in addition or alternative, the crucible 22 may include any other shape that enables the crucible 22 to function as described and/or illustrated herein. In some embodiments, the crucible 22 is configured to be thermal shock resistant to relatively rapid heating and is sufficiently strong and inert to contain molten filler material 12 (e.g., GTD444 alloy, Renè™ 142 alloy, and N5 alloy) at at least approximately 1550° C. for at least approximately 30 minutes. The melting chamber 26 of the crucible 22 may have any capacity, such as, but not limited to, greater than approximately 30 grams, and/or the like. For example, for repair and/or joining operations that each uses approximately 2 grams or less than approximately 2 grams, a 30 gram capacity of the melting chamber 26 may enable up to four or five individual repair and/or joining operations, for example because a predetermined amount of the filler material 12 may need to remain in the melting chamber 26 to enable adjustment of the electromagnetic levitation and/or melting.

The filler material 12 may include any substance(s) such that the filler material 12 is capable of being electromagnetically levitated, transformed into a completely molten state (i.e., heated to a state above the liquidus temperature of the filler material 12), delivered to the substrate material 14 in the molten state, and joined with the substrate material 14. In some embodiments, the filler material 12 is superheated by 200° C. or greater. The filler material 12 may be capable of being delivered to the target site 18 of the substrate material in a continuous molten stream. Examples of substances that may be included within the filler material 12 include, but are not limited to, ferrous substances, non-ferrous substances, metallic substances, electrically conductive substances, metals, alloys, ceramics, super alloys, and/or the like. In some embodiments, the filler material 12 includes a relatively low amount, or no, silicon. In some embodiments, the filler material 12 includes a nickel-based super alloy, such as, but not limited to, nickel-based super alloys used in gas turbine engines for relatively hot gas path applications, and/or the like. For example, the filler material 12 may include the commercially available Rene™ N5 alloy or the commercially available Rene™ 142 alloy. Moreover, in some embodiments, the filler material 12 includes a cobalt-bases super alloy such as, but not limited to, cobalt-based super alloys used in gas turbine engines for relatively hot gas path applications, and/or the like. As described above, the filler material 12 is capable of being electromagnetically levitated. Substances that are currently known to be capable of being electromagnetically levitated include, but are not limited to, ferrous substances, non-ferrous substance, metallic substances, and electrically conductive substances. But, the filler material 12 may include or be formed entirely from other substances (e.g., non-electrically conductive substances, non-metallic substances, and/or the like) so long as the filler material 12 is capable of being electromagnetically levitated (e.g., if such substances are determined to be capable of being electromagnetically levitated).

In some embodiments, the composition of the filler material 12 is identical to the composition of the substrate material 14 or is similar to the composition of the substrate material 14. Such embodiments wherein the composition of the filler material 12 is identical or similar to the composition of the substrate material 14 may reduce or prevent shrinkage, cracking, and/or other performance defects because the filler material 12 and the substrate material 14 possess the same or similar physical characteristics. Furthermore, such embodiments may provide a closer match of physical properties between the substrate material 14 and the filler material 12 to potentially allow for increased and/or more predictable performance. In some embodiments, such as wherein the substrate material 14 comprises a single crystal, the filler material 12 may be similar but not the same in composition as the substrate material 14 because of grain boundaries at the target site 18. For example, when the substrate material 14 includes a single crystal Rene™ N5, the filler material 12 may include Renè™ 142.

The filler material 12 may be supplied to the melting chamber 26 of the crucible 22 in any state, structure, form, configuration, size, shape, quantity, and/or the like, such as, but not limited to, as one or more ingots, as one or more pellets, as one or more rods, as one or more blocks, as one or more wires, as a powder, as a slurry, and/or the like.

As described above, the system 10 includes the heating unit 24, which includes the heating element 20 for transforming the filler material 12 into a molten state. Specifically, the heating element 20 is operatively connected to the crucible 22 such that the heating element 20 is configured to heat the filler material 12 within the melting chamber 26 of the crucible 22 to thereby transform the filler material 12 into a molten state. In other words, the heating element 20 is configured to melt the filler material 12 within the melting chamber 26 such that the filler material 12 is molten. The heating element 20 may be configured to maintain the filler material 12 within the melting chamber 26 as molten and/or within a predetermined temperature range, for example for a predetermined amount of time before the molten filler material 12 is applied to the substrate material 14.

The heating element 20 may be any type of heating element that is capable of applying enough energy (e.g., heat) to the filler material 12 within the melting chamber 26 of the crucible 22 such that the filler material 12 becomes molten. In the exemplary embodiment of the system 10, the heating element 20 is an induction coil 20a. The heating unit 24 includes a power supply 28 that is operatively connected to the induction coil 20a through an electrical connection 30. The power supply 28 supplies an electrical current (e.g., an alternating electrical current) to the induction coil 20a. The electrical current energizes the induction coil 20a such that the induction coil 20a generates an electromagnetic field that heats the filler material 12 within the melting chamber 26 via resistive heating. In the exemplary embodiment of the system 10, the induction coil 20a is wound around the circumference of the crucible 22. But, the induction coil 20a may have any other operable configuration near and/or around the melting chamber 26 of the crucible 22. Although shown and described as being an induction coil 20a, the heating element 20 may additionally or alternatively include any other type of heating element, such as, but not limited to, an arc welding apparatus (e.g., TIG welding), a gas welding apparatus (e.g., oxyacetylene welding), an energy beam welding apparatus (e.g., laser beam welding), a microwave, and/or the like.

The system 10 may include an inlet system 32 that is operatively connected to a source of vacuum (not shown) and/or to a source of a relatively low pressure inert gas (not shown). The inlet system 32 is configured to apply a vacuum to, and/or inject an inert gas into, the melting chamber 26 before, during, and/or after melting of the filler material 12, for example to facilitate preventing oxidation of the filler material 12. For example, the filler material 12 may be melted within the melting chamber in a non-oxidizing environment. The source of vacuum may be a vacuum pump and/or any other source of vacuum. The inert gas may be any type of inert gas (e.g., argon), and may be supplied to the melting chamber 26 at any pressure. The inlet system 32 may include various flow and/or atmospheric control features (not shown), such as, but not limited to, valves, restrictors, blowouts, pumps, vacuum pumps, sensors, control units, processors, manual shutoffs, automatic shutoffs, hoses, conduits, piping, tubing, insulation, and/or the like. For example, in the exemplary embodiment of the system 10, the inlet system 32 includes one or more valves 34 that are fluidly connected between the melting chamber 26 and the source of vacuum and/or the source of inert gas. Such a valve 34 may be may be any type of valve, such as, but not limited to, a two-port valve, a three-port valve, a four-port valve, a switch, and/or the like. In some embodiments, the valve 34 is a relatively high speed digital switch. For example, a relatively high speed vacuum/pressure switch with an approximately 0.0025 second response time may be used to control a transition from vacuum to pressure within approximately 0.01 second.

Referring again to the crucible 22, the crucible 22 extends from a top 36 to a bottom 38. In the exemplary embodiment of the system 10, the top 36 includes an opening 40 that is open to the melting chamber 26. The opening 40 provides an inlet for loading the filler material 12 and/or other substances (e.g., a gas, applying a vacuum, and/or the like) into the melting chamber 26. Although only one is shown, the crucible 22 may include any number of openings 40 in the top 36. Moreover, in addition or alternative to extending through the top 36, the crucible 22 may include one or more openings (not shown) that extend through any side(s) 42 of the crucible 22 for providing an inlet for loading the filler material 12 and/or other substances into the melting chamber 26.

The crucible 22 includes an outlet system 44 that is fluidly connected to the melting chamber 26. The outlet system 44 may include any structure, configuration, means, arrangement, and/or the like that facilitates the delivery of molten filler material 12 from the melting chamber 26 to the target site 18 of the substrate material 14. In some embodiments, the outlet system 44 is configured to deliver molten filler material 12 from the melting chamber 26 to the target site 18 of the substrate material 14 in a continuous molten stream. The outlet system 44 and/or one or more components thereof (e.g., the opening 46 and the nozzle 50 described below) may be referred to herein as an “outlet” of the melting chamber 26.

In some embodiments, the outlet system 44 is configured to deliver molten filler material 12 to the target site 18 of the substrate material 14 at a flow rate of at least approximately 2 meters per second (m/s), for example under a pressure of between approximately 4 psi and approximately 16 psi. Moreover, in some embodiments, the outlet system 44 is configured to deliver to the target site 18 of the substrate material 14 a continuous molten stream of filler material 12 that is at least approximately 10 centimeters (cm) long, at least approximately 20 cm long, and/or the like, for example under a pressure of between approximately 4 psi and approximately 16 psi. At a flow rate of approximately 3 m/s, the temperature loss of an approximately 20 cm long continuous molten stream of filler material 12 may be less than approximately 10° C.

The outlet system 44 includes one or more openings 46 that are open to the melting chamber 26. The opening 46 provides an outlet for releasing molten filler material 12 from the melting chamber 26 of the crucible. In the exemplary embodiment of the system 10, the opening 46 extends through the bottom 38 of the crucible 22. But, in addition or alternative to extending through the bottom 38, the outlet system 44 may include one or more openings 46 that extend through any side(s) 42 and/or the top 36 of the crucible 22. Although only a single opening 46 is shown, the outlet system 44 may include any number of the openings 46.

The outlet system 44 may include a nozzle 50. The nozzle 50 is fluidly connected to the opening 46 for applying the filler material 12 to the target site 18 of the substrate material 14, as will be described in more detail below.

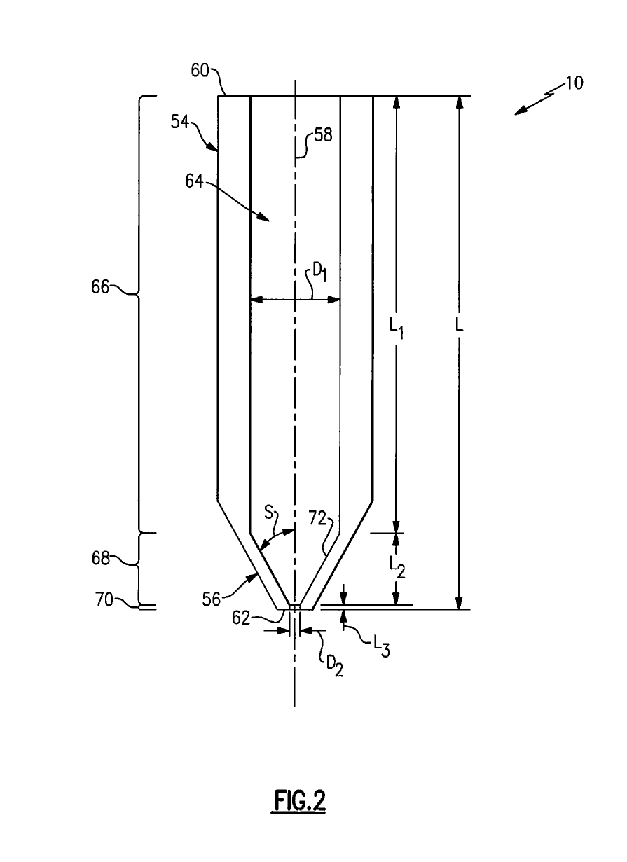

FIG. 2 is a cross sectional view of an exemplary embodiment of the nozzle 50. The nozzle 50 includes a base 54 and a tip 56. The nozzle 50 extends a length L along a central longitudinal axis 58 from an end surface 60 of the base 54 to a tip surface 62 of the tip 56. The nozzle 50 may have any length L. In some embodiments, the length L of the nozzle 50 is selected to facilitate delivering molten filler material 12 (shown in FIGS. 1 and 5) in a continuous molten stream, to facilitate preventing the loss of heat from the molten filler material 12, and/or to facilitate prevent contamination to the molten filler material 12 (e.g., from contact with the nozzle 50 and/or the atmosphere). Examples of the length L of the nozzle 50 include, but are not limited to, between approximately 50 mm and approximately 250 mm, greater than approximately 50 mm, greater than approximately 149 mm, and/or the like.

The nozzle 50 includes an opening 64 that extends through the length L of the nozzle 50, as can be seen in FIG. 2. The opening 64 includes an entrance segment 66, a tapered segment 68, and an outlet segment 70. The entrance segment 66 extends through the end surface 60 and along the base 54. The outlet segment 70 extends through the tip surface 62. The tapered segment 68 extends between, and fluidly interconnects, the entrance segment 66 and the outlet segment 70.

The entrance segment 66 of the opening 64 extends a length L₁. In the exemplary embodiment of the system 10, the entrance segment 66 is directly fluidly connected to the opening 46 (shown in FIGS. 1 and 5) of the crucible 22 (shown in FIGS. 1 and 5) for receiving molten filler material 12 therefrom. The entrance segment 66 may have any length L₁. In some embodiments, the length L₁ of the entrance segment 66 is selected to facilitate delivering molten filler material 12 in a continuous molten stream, to facilitate preventing the loss of heat from the molten filler material 12, and/or to facilitate prevent contamination to the molten filler material 12. Examples of the length L₁ of the entrance segment 66 include, but are not limited to, between approximately 30 mm and approximately 230 mm, greater than approximately 30 mm, greater than approximately 129 mm, and/or the like.

The entrance segment 66 includes a diameter D₁. In the exemplary embodiment of the system 10, the diameter D₁ of the entrance segment 66 is approximately constant along the length of the entrance segment 66. But, alternatively, the diameter D₁ of the entrance segment 66 is variable along the length thereof. The entrance segment 66 may have any diameter D₁. The diameter D₁ of the entrance segment 66 may or may not be the same or similar to the diameter of the opening 46. In some embodiments, the diameter D₁ of the entrance segment 66 and/or the relation of the diameter D₁ to the diameter of the opening 46 is selected to facilitate delivering molten filler material 12 in a continuous molten stream, to facilitate preventing the loss of heat from the molten filler material 12, and/or to facilitate prevent contamination to the molten filler material 12. Examples of the diameter D₁ of the entrance segment 66 include, but are not limited to, between approximately 10 mm and approximately 30 mm, greater than approximately 10 mm, greater than approximately 19 mm, and/or the like.

The tapered segment 68 of the opening 64 extends a length L₂, which may be any length L₂. In some embodiments, the length L₂ of the tapered segment 68 is selected to facilitate delivering molten filler material 12 in a continuous molten stream, to facilitate preventing the loss of heat from the molten filler material 12, and/or to facilitate prevent contamination to the molten filler material 12. Examples of the length L₂ of the tapered segment 68 include, but are not limited to, between approximately 9 mm and approximately 29 mm, greater than approximately 9 mm, greater than approximately 28 mm, and/or the like.

The tapered segment 68 tapers radially inward (relative to the central longitudinal axis 58) as the tapered segment 68 extends from the entrance segment 66 to the outlet segment 70. In other words, the tapered segment 68 narrows the width of the opening 64. The taper of the tapered segment 68 is defined by a sloped interior wall 72 of the nozzle 50. Specifically, the interior wall 72 has a slope S that extends radially inward as the tapered segment 68 extends to the outlet segment 70. The interior wall 72 may have any slope S that gives the tapered segment 68 any amount of taper. In some embodiments, the amount of taper of the tapered segment 68 is selected to facilitate delivering molten filler material 12 in a continuous molten stream, to facilitate preventing the loss of heat from the molten filler material 12, and/or to facilitate prevent contamination to the molten filler material 12. Examples of the slope S of the interior wall 72 include, but are not limited to, between approximately 20° and approximately 40°, greater than approximately 20°, greater than approximately 39°, and/or the like. In the exemplary embodiment of the system 10, the slope S of the interior wall 72 is approximately constant along the length of the tapered segment 68. But, alternatively, the slope S of the tapered segment 68 is variable along the length thereof.

The outlet segment 70 of the nozzle 50 is used to apply the filler material 12 to the target site 18 of the substrate material 14. For example, the outlet segment 70 provides an outlet where the molten filler material 12 exits the outlet system 44 for application to the substrate material 14. In some embodiments, the outlet segment 70 is configured such that the nozzle 50 is configured to deliver molten filler material 12 to the substrate material 14 in a continuous molten stream. The outlet segment 70 may be referred to herein as an “outlet opening”.

The outlet segment 70 of the opening 64 includes a diameter D₂. The outlet segment 70 may have any diameter D₂. The outlet segment 70 extends a length L₃, which may be any length L₃. In some embodiments, the length L₃ of the outlet segment 70 is selected to facilitate delivering molten filler material 12 in a continuous molten stream, to facilitate preventing the loss of heat from the molten filler material 12, and/or to facilitate prevent contamination to the molten filler material 12. Examples of the length L₃ of the outlet segment 70 include, but are not limited to, between approximately 0.5 mm and approximately 2 mm, greater than approximately 0.5 mm, greater than approximately 1.9 mm, and/or the like. In some embodiments, the length L₃ of the outlet segment 70 is selected to provide a flow rate of molten filler material 12 through the outlet system 44 of at least approximately 2 m/s, for example under a pressure of between approximately 4 psi and approximately 16 psi. Moreover, in some embodiments, the length L₃ of the outlet segment 70 is selected to deliver a continuous molten stream of filler material 12 that is at least approximately 10 centimeters (cm) long, at least approximately 20 cm long, and/or the like, for example under a pressure of between approximately 4 psi and approximately 16 psi.

The nozzle 50 may include any substance(s) that enables the nozzle 50 to function as described and/or illustrated herein. The nozzle 50 may be fabricated from the same or similar substances as the crucible 22 or may be fabricated from alternative or additional substances from the crucible 22. Examples of suitable substances of the nozzle 50 include, but are not limited to, oxides, carbides, nitrides, alumina-based ceramics, alumina, porous alumina, boron nitride, quartz, ceramics, refractory ceramics, metallic cold hearths, a substance that is susceptible to induction heating, and/or the like. The nozzle 50 may be integrally formed with the crucible 22 (e.g., from the same substance(s) of the crucible 22) or may be formed as a discrete component from the crucible 22 that is thereafter attached to the crucible 22.

The nozzle 50 shown in FIG. 2 is intended as exemplary only. In other words, the outlet system 44 is not limited to the specific embodiment of the nozzle 50 that is shown and described herein. Rather, in addition or alternative to the nozzle 50, the outlet system 44 may include other nozzles (not shown) having other shapes, sizes, components, configurations, arrangement, and/or the like.

Referring again to FIG. 1, as briefly described above, the system 10 includes the flow control mechanism 74. The flow control mechanism 74 is operatively connected to the crucible 22 for controlling the flow of molten filler material 12 through the outlet system 44. For example, the flow control mechanism 74 is configured to electromagnetically levitate filler material 12 within the melting chamber 26 of the crucible 22 to hold molten filler material 12 within the melting chamber 26. Specifically, the flow control mechanism 74 is configured to prevent molten filler material 12 from exiting the outlet system 44 by electromagnetically levitating the filler material 12 within the melting chamber 26. Moreover, the flow control mechanism 74 is configured to release the electromagnetic levitation from the filler material 12 to enable molten filler material 12 to exit the outlet system 44 and thereby exit the melting chamber 26 of the crucible 22. In some embodiments, in addition or alternative to releasing the electromagnetic levitation, an inert gas is injected into the melting chamber 26 to eject molten filler material 12 from the melting chamber 26 through the outlet system 44. Moreover, in addition or alternative to using electromagnetic levitation to control the flow of molten filler material 12 through the outlet system 44, the flow control mechanism 74 may use pressure differentials to control the flow of molten filler material 12 through the outlet system 44, for example as is described in U.S. patent application Ser. No. ______, filed on Sep. 27, 2012, and entitled “METHODS AND SYSTEMS FOR JOINING MATERIALS” (Attorney Docket No. 258830 (551-0074US)).

As used herein, the term “electromagnetically levitate” is intended to mean holding filler material 12 with a sufficient force such that the filler material 12 is prevented from exiting the outlet system 44. For example, “electromagnetically levitating” filer material 12 may include exerting a holding force on the filler material 12 that acts in a direction (e.g., the direction of the arrow A in FIG. 1) that is opposite gravity, wherein the holding force is greater than the gravitational forces acting on the filler material 12 (e.g., in the direction of the arrow B in FIG. 1) such that the filler material 12 is prevented from being pulled through the outlet system 44 by the gravitational forces. In other words, and for example, the holding force may act on filler material 12 in a direction (e.g., the direction A) that is opposite a head pressure of the filler material 12 at the outlet system 40.

“Electromagnetically levitating” filler material 12 may or may not include lifting the filler material 12 away from an interior wall 76 of the melting chamber 26. Moreover, the holding force exerted on the filler material 12 by the electromagnetic levitation is not limited to overcoming gravity to hold filler material 12 within the melting chamber 26. Rather, in addition or alternative to overcoming gravitational forces, the holding force exerted on the filler material 12 by the electromagnetic levitation may overcome a pressure within the melting chamber 26 to hold filler material 12 within the melting chamber 26. However, and as will be described in more detail below, in some embodiments, the melting chamber 26 may be pressurized (e.g., by injecting an inert gas into the melting chamber 26) to eject filler material 12 from the melting chamber 26 through the outlet system 44. In such embodiments, the holding force exerted on the filler material 12 by the electromagnetic levitation may be greater than any initial pressure within the melting chamber 26 before the melting chamber 26 is pressurized (and/or any gravitational forces acting on the filler material 12).

In some embodiments, the outlet system and/or one or more components thereof (e.g., the opening 46 and the nozzle 50) are considered part of the melting chamber 26. Accordingly, “electromagnetically levitating” filler material 12 within the melting chamber 26 may include preventing any filler material 12 that is already in the outlet system 44 from exiting the outlet system 44 or from traveling further downstream within the outlet system 44. But, in some embodiments, “electromagnetically levitating” filler material 12 within the melting chamber 26 includes preventing filler material 12 from flowing into the outlet system 44 such that no filler material 12 is within the outlet system 44 during the “electromagnetic levitation”. Moreover, in other embodiments, “electromagnetically levitating” filler material 12 within the melting chamber 26 includes drawing filler material 12 that is already within the outlet system 44 at least partially upstream within the outlet system 44 (e.g., such that no filler material 12 is within the outlet system 44). In other words, “electromagnetically levitating” filler material 12 within the melting chamber 26 may or may not include separating filler material 12 from a segment or all of the outlet system 44 (e.g., the opening 46 and the segments 70, 68, and 66 of the nozzle 50). For example, in some embodiments, the holding force exerted on the filler material 12 is not sufficient to separate filler material 12 from any segment of the outlet system 44.

The flow control mechanism 74 may include any component that is capable of electromagnetically levitating filler material 12 within the melting chamber 26 of the crucible 22. In the exemplary embodiment of the system 10, the induction coil 20a is used to electromagnetically levitate the filler material 12 within the melting chamber 26. The power supply 28 is used to energize the induction coil 20a to electromagnetically levitate filler material 12 within the melting chamber 26. When energized, a magnetic field is generated from the induction coil 20a. According to Lenz's law, the magnetic field generated from the induction coil 20a induces an opposite magnetic field within the filler material 12. The interaction between the magnetic fields generated from the induction coil 20a and the filler material 12 exerts the holding force on the filler material 12, which as described above may act in the direction A. Specifically, the magnetic field induced within the filler material 12 opposes the magnetic field generated from the induction coil 20a and thereby exerts the holding force on the filler material 12. The magnetic field induced within the filler material 12 and the magnetic field generated from the induction coil 20a may alternate.

The power source 28 may energize the induction coil 20a with any energization scheme (e.g., any amount of voltage and/or any amount of current) that electromagnetically levitates filler material 12 with a holding force having any value. The induction coil 20a may have any configuration, any arrangement, any structure, any shape, any size, any number of turns, any sized turns, any number of different turn directions, any overall length, any number of differently configured segments, and/or the like that enable the induction coil 20a to electromagnetically levitate filler material 12 within the melting chamber 26 of the crucible 22. In the exemplary embodiment of the system 10, the induction coil 20a is wound around the circumference of the crucible 22. But, the induction coil 20a may have any other operable configuration near and/or around the melting chamber 26 of the crucible 22 that enables the induction coil 20a to electromagnetically levitate filler material 12 within the melting chamber 26. Moreover, in the exemplary embodiment of the system 10, the induction coil 20a includes an upper coil segment 78 and a lower coil segment 80. As can be seen in FIG. 1, the turns of the upper coil segment 78 are reversed relative to the turns of the lower coil segment 80. Specifically, in the exemplary embodiment of the system 10, the turns of the upper coil segment 78 extend in a clockwise direction, while the turns of the lower coil segment 80 extend in a counter-clockwise direction. The different directions of the turns of the upper coil segment 78 and the turns of the lower coil segment 80 may generate magnetic field gradients vertically through the induction coil 20a. Such vertical magnetic field gradients provide the electromagnetic levitation that exerts the holding force on the filler material 12. Moreover, the different directions of the turns of the upper coil segment 78 and the lower coil segment 80 may facilitate exerting the holding force in the direction A because the magnetic fields cancel out at the interface between the coil segments 78 and 80, which thereby creates a greater magnetic force below (as viewed in FIG. 1) the filler material 12 than above (as viewed in FIG. 1) the filler material 12.

In other embodiments, the clockwise and counter-clockwise directions of the turns of the upper and lower coil segments 78 and 80, respectively, may be reversed, such that the turns of the upper coil segment 78 extend in a counter-clockwise direction and the turns of the lower coil segment 80 extend in a clockwise direction. Moreover, in other embodiments, the turns of the upper and lower coil segments 78 and 80, respectively, may extend in the same direction as each other (whether clockwise or counter-clockwise). Although two are shown, the induction coil 20a may include any other number of coil segments. Moreover, each coil segment (e.g., each of the upper coil segment 78 and the lower coil segment 80) of the induction coil 28 may include any number of turns that extend in any direction.

In the exemplary embodiment of the system 10, the upper coil segment 78 and the lower coil segment 80 are shown as being discretely electrically connected to the power source 28. Specifically, the upper coil segment 78 is electrically connected to the power source 28 through an electrical connection 30a, while the lower coil segment 80 is electrically connected to the power source 28 through a different electrical connection 30b. Alternatively, the upper coil segment 78 and the lower coil segment 80 are electrically connected to the power source 28 through a common electrical connection (e.g., as with the induction coil 120 shown in FIG. 3). When the upper and lower coil segments 78 and 80, respectively, are discretely electrically connected to the power source 27, the upper coil segment 78 may be energized in the same energization scheme (e.g., supplied with the same voltage and the same current) as the lower coil segment 80 to heat and/or electromagnetically levitate the filler material 12. But, in other embodiments, the upper coil segment 78 may be energized in a different energization scheme (e.g., supplied with a different voltage and/or a different current) as the lower coil segment 80 to heat and/or electromagnetically levitate the filler material 12 in embodiments wherein the upper and lower coil segments 78 and 80, respectively, are discretely electrically connected to the power source 27.

As described above, the induction coil 20a may have any shape that enables the induction coil 20a to electromagnetically levitate filler material 12 within the melting chamber 26 of the crucible 22. In the exemplary embodiment of the system 10, the induction coil 20a includes a conical shape. Specifically, the upper coil segment 78 of the induction coil 20a has the general shape of a right circular cylinder. The lower coil segment 80 of the induction coil 20a extends from a top 82 to a bottom 84. At the top 82, the lower coil segment 80 has the general shape of a right circular cylinder. But, the lower coil segment 80 tapers radially inward at the bottom 84, as can be seen in FIG. 1. The taper of the bottom 84 of the lower coil segment 80 gives the induction coil 20a the general shape of conical cylinder. The taper of the bottom 84 of the lower coil segment 80 may facilitate exerting the holding force in the direction A because the narrower diameter of the bottom 84 creates a greater magnetic force below (as viewed in FIG. 1) the filler material 12 than above (as viewed in FIG. 1) the filler material 12.

FIG. 3 is a perspective view of another exemplary embodiment of an induction coil 120 of the system 10 for electromagnetically levitating filler material 12 (shown in FIGS. 1 and 5) within the melting chamber 26 (shown in FIGS. 1 and 5) of the crucible 22 (shown in FIGS. 1 and 5). The induction coil 120 includes an upper segment 178 and a lower segment 180. The turns of the upper coil segment 178 are reversed relative to the turns of the lower coil segment 180. The upper coil segment 178 and the lower coil segment 180 are electrically connected to the power source 28 through a common electrical connection 130. Specifically, an end 186 of the upper coil segment 178 is electrically connected to the power source 28, while an end 188 of the lower coil segment 180 is electrically connected to the power source 28. The upper coil segment 178 extends from the lower coil segment 180, and vice versa, such that a continuous electrical path is defined along the induction coil 120 from the end 186 of the upper coil segment 178 to the end 188 of the lower coil segment 180.

In the exemplary embodiment of FIG. 3, the induction coil 120 has the general shape of a conical cylinder. Specifically, the upper coil segment 178 of the induction coil 120 has the general shape of a right circular cylinder, while the lower coil segment 180 of the induction coil 120 tapers radially inward at a bottom 184 thereof.

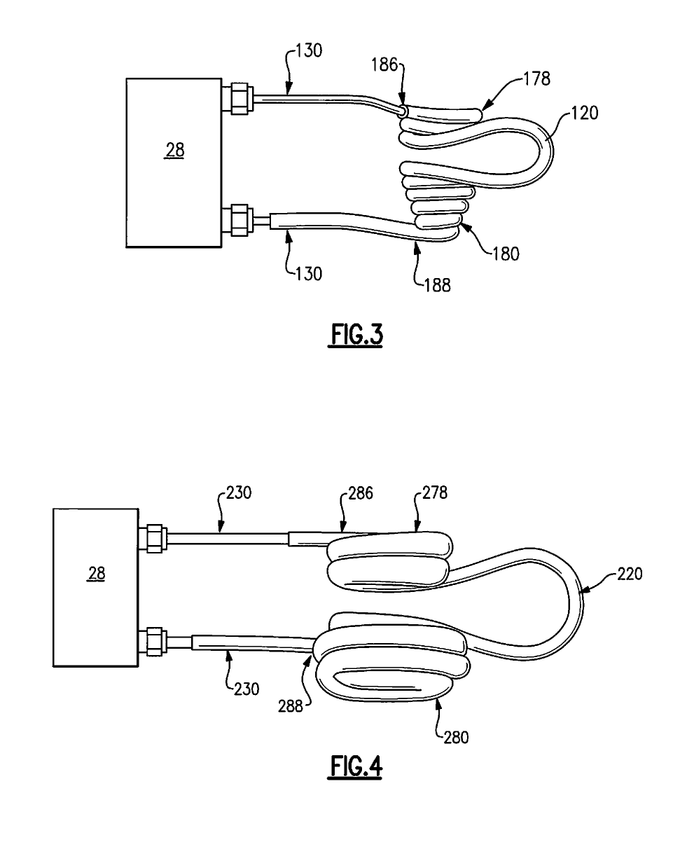

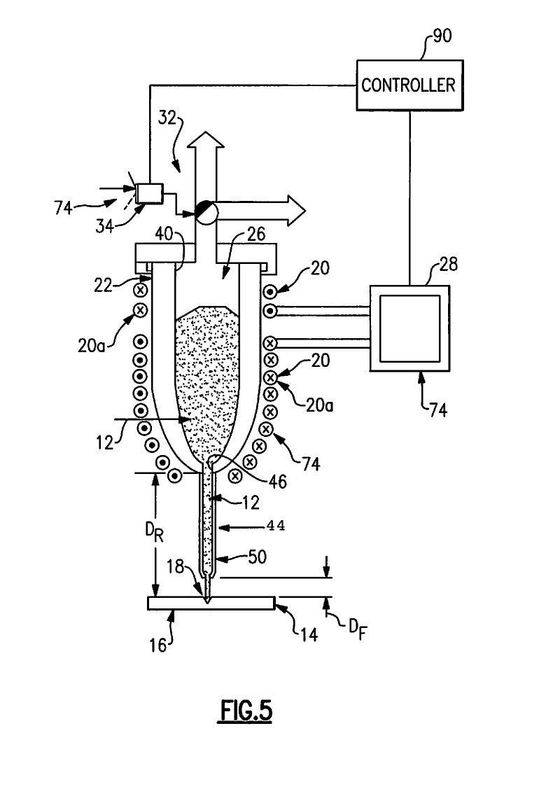

FIG. 4 is a perspective view of another exemplary embodiment of an induction coil 220 of the system 10 for electromagnetically levitating filler material 12 (shown in FIGS. 1 and 5) within the melting chamber 26 (shown in FIGS. 1 and 5) of the crucible 22 (shown in FIGS. 1 and 5). The induction coil 220 includes an upper segment 278 and a lower segment 280. The turns of the upper coil segment 278 are reversed relative to the turns of the lower coil segment 280. In the exemplary embodiment of FIG. 4, the induction coil 220 has the general shape of a right circular cylinder. Specifically, both the upper coil segment 278 and the lower coil segment 280 of the induction coil 220 have the general shape of a right circular cylinder.

The upper coil segment 278 and the lower coil segment 280 are electrically connected to the power source 28 through a common electrical connection 230. Specifically, an end 286 of the upper coil segment 278 is electrically connected to the power source 28, while an end 288 of the lower coil segment 280 is electrically connected to the power source 28. The upper coil segment 278 extends from the lower coil segment 280, and vice versa, such that a continuous electrical path is defined along the induction coil 220 from the end 286 of the upper coil segment 278 to the end 288 of the lower coil segment 280.

Referring again to FIG. 1, in addition or alternative to the induction coil 20a, the flow control mechanism 74 may include any other type of electromagnetic levitation component that is configured to electromagnetically levitate filler material 12 within the melting chamber 26. Moreover, although in the exemplary embodiment of the system 10 the induction coil 20a is used for both melting and electromagnetically levitating filler material 12 within the melting chamber 26, in other embodiments the heating element 20 and the component that is used to electromagnetically levitate filler material 12 within the melting chamber 26 are discrete components from each other. Moreover, although the power supply 28 is used for both melting and electromagnetically levitating filler material 12 within the melting chamber 26, in other embodiments the system 10 includes discrete power supplies for melting filler material 12 and for electromagnetically levitating filler material 12.

In the exemplary embodiment of the system 10, the flow control mechanism 74 includes the inlet system 32, which is operatively connected to a supply of an inert gas for injecting the inert gas into the melting chamber 26 to eject molten filler material 12 from the melting chamber 26 through the outlet system 44. The inert gas may be any type of inert gas (e.g., argon), and may be supplied to the melting chamber 26 at any pressure. The supply of inert gas used to eject molten filler material 12 from the melting chamber 26 may be the same or a different supply as the supply (described above) that is injected into the melting chamber 26 before, during, and/or after melting of the filler material 12. As described above, the inlet system 32 may include various flow and/or atmospheric control features (not shown), such as, but not limited to, valves, restrictors, blowouts, pumps, vacuum pumps, sensors, control units, processors, manual shutoffs, automatic shutoffs, hoses, conduits, piping, tubing, insulation, and/or the like. For example, in the exemplary embodiment of the system 10, the inlet system 32 includes the valve 34, which is fluidly connected between the melting chamber 26 and the source of inert gas. Although in the exemplary embodiment of the system 10 the same inlet system 32 is used for both ejecting molten filler material 12 from the melting chamber 26 and for injecting the inert gas into, and/or applying a vacuum to, the melting chamber 26 before, during, and/or after melting of filler material 12, in other embodiments discrete inlet systems 32 are used.

In addition to the electromagnetic levitation components (e.g., the induction coil 20a and the power source 28), the flow control mechanism 74 may include one or more gates (not shown), one or more plugs (not shown), one or more valves (not shown), and/or one or more other flow control device that prevent filler material 12 from exiting the inciting chamber 26 through the outlet system 44. For example, in some embodiments, a gate, plug, valve, and/or other flow control device is positioned within the opening 46 and/or at another location of the outlet system 44. The gate, plug, valve, and/or other flow control device may transition between a closed position wherein the gate, plug, valve, and/or other flow control device blocks filler material 12 from exiting the outlet system 44 and an open position wherein the gate, plug, valve, and/or other flow control device does not block filler material 12 from exiting the outlet system 44. In some embodiments, the opening 46 is sized such that an overpressure of filler material 12 is required before filler material 12 can pass through the opening 46. In such embodiments, filler material 12 may be exhausted from the melting chamber 26 in intervals.

The system 10 may include one or more controllers 90 and/or other sub-systems for controlling operation of the system 10. For example, the controller 90 may control operation of the heating element 20, the flow control mechanism 74, the inlet system 32, any sensors of the system 10, any gates, plugs, valves, and/or other flow control devices of the system 10, and/or the like. Examples of the operations of the various components of the system 10 that may be controlled by the controller 90 include, but are not limited to, initiation of the heating element 20, the amount of heat imparted to the filler material 12 by the heating element 20, initiation of electromagnetic levitation of the filler material 12, the amount of holding force exerted on the filler material 12 by the electromagnetic levitation, initiation of energization of the induction coil 20a (e.g., for heating and/or for electromagnetic levitation), the specific energization scheme of the induction coil 20a (e.g., for heating and/or for electromagnetic levitation), initiation of injection of an inert gas into the melting chamber 26 (e.g., during melting of filler material 12 and/or to eject molten filler material 12 from the melting chamber 26), the type, amount, and/or pressure of inert gas injected into the melting chamber 26, the application of a vacuum to the melting chamber 26, and/or the like. Other exemplary operations of the controller 90 include, but are not limited to, monitoring one or more sensors of the system 10 that determine the amount and/or rate of heat being imparted to the filler material 12, monitoring one or more sensors of the system 10 that determine the temperature of the filler material 12 and/or whether the filler material 12 has reached the liquidus temperature of the filler material 12, monitoring one or more sensors of the system 10 that determine the amount of electromagnetic levitation (i.e., the amount of holding force) being applied to the filler material 12, monitoring one or more sensors of the system 10 that determine a flow rate of molten filler material 12 through the outlet system 44, and/or the like.

In operation, and referring now to FIGS. 1 and 5, filler material 12 is loaded into the melting chamber 26 of the crucible 22, for example through the opening 40. As described above, the filler material 12 may be in any state and may have any structure, form, configuration, size, shape, quantity, and/or the like when the filler material 12 is loaded into the melting chamber 26. The induction coil 20a is energized using the power source 28 to thereby heat the filler material 12 within the melting chamber 26. Once a sufficient amount of heat is imparted to the filler material 12, the filler material 12 melts and is thereby transformed into a molten state. Both FIGS. 1 and 5 illustrate the filler material 12 as molten.

In some embodiments, melting the filler material 12 includes superheating the filler material 12 to a temperature exceeding the liquidus temperature of the filler material 12, for example to facilitate ensuring that molten filler material 12 flows throughout and completely fills the target site 18 (not shown in FIG. 1) of the substrate material 14 (not shown in FIG. 1) prior to cooling and solidifying. The induction coil 20a may be configured to maintain the filler material 12 within the melting chamber 26 as molten and/or within a predetermined temperature range, for example for a predetermined amount of time before molten filler material 12 is applied to the substrate material 14. In some embodiments, the system 10 is configured to heat a super alloy filler material 12 from room temperature to approximately 1550° C. within approximately 15 minutes, and allow a dwell time of equal to or greater than approximately 30 minutes without thermal shock, mechanical failures, melt contaminations, and/or the like.

As described above, melting the filler material 12 may be performed at a remote distance D_{R} (not shown in FIG. 1) from the target site 18 of the substrate material 14. The remote distance D_{R} includes any distance between the target site 18 and the system 10 (e.g., the heating element 20, the crucible 22, and any molten filler material 12 in the crucible 22) that is large enough that the target site 18 does not rise above the solidus and/or recrystallization temperature of the target site 18 as a result of the radiant energy from the system 10. The remote distance D_{R} may have a dimension such that melting of the filler material 12 is performed within the same facility or within a different facility as the location of the target site 18 of the substrate material 14. The remote distance D_{R} may depend, for example, on the amount of energy applied to the filler material 12 from the heating element 20, the amount of time energy is applied to the filler material 12, the particular substance(s) that compose the target site 18 of the substrate material 14, the amount of energy radiating from the heating element 20, the amount and/or temperature of any molten filler material 12 contained within the melting chamber 26, and/or any insulating barriers between the system 10 and the target site 18. In some embodiments, some radiant energy from the system 10 may heat the target site 18 to a temperature below the solidus and/or recrystallization temperature of the target site 18. In such embodiments, such heating may be taken into account when potentially preheating the target site 18 as discussed below. The ability of the filler material 12 to be melted at a remote distance D_{R} from the target site 18 is also described in U.S. patent application Ser. No. 13/453,097, filed on Apr. 23, 2012, and entitled “REMOTE MELT JOINING METHODS AND REMOTE MELT JOINING SYSTEMS” (Attorney Docket No. 248718).

Melting of filler material 12 may be performed in a variety of environments. For example, in some embodiments, melting of the filler material 12 may occur in an inert atmosphere. Specifically, the system 10 may inject an inert gas into the melting chamber 26 (e.g., using the inlet system 32) before and/or during melting of the filler material 12, as is described above. The inert gas may be any type of inert gas, and may be supplied to the melting chamber 26 at any pressure. In other embodiments, melting of filler material 12 occurs in a low pressure (e.g., vacuum) environment. For example, the system 10 may apply a vacuum to the melting chamber 26 (e.g., using the inlet system 32) before and/or during melting of the filler material 12. In still other embodiments, melting of filler material 12 may occur in any other type of environment that enables the system 10 to produce molten filler material 12 for delivery to the target site 18 of the substrate material 14.

The filler material 12 is electromagnetically levitated within the melting chamber 26. Specifically, the power source 28 is used to energize the induction coil 20a and thereby electromagnetically levitate the filler material 12. As is described above, the filler material 12 is electromagnetically levitated to hold molten filler material 12 within the melting chamber 26 (i.e., prevent molten filler material 12 from exiting the outlet system 44). As shown in FIG. 1, the electromagnetic levitation holds the filler material 12 at the opening 46 such that no filler material 12 is within the outlet system 40. But, in other embodiments, circumstances, situations, process steps, and/or the like, the electromagnetic levitation may hold the filler material 12 at the outlet segment 70 of the nozzle 50 such that filler material 12 generally fills the outlet system 44 and is prevented from exiting the nozzle 46. In still other embodiments, circumstances, situations, process steps, and/or the like, the electromagnetic levitation may hold the filler material 12 at another segment of the outlet system 44 such that filler material 12 fills only a portion of the outlet system 44. In even further embodiments, circumstances, situations, process steps, and/or the like, the electromagnetic levitation ΔP_{I} may draw filler material 12 that is already within the outlet system 44 at least partially upstream within the outlet system 44.

In some embodiments, the electromagnetic levitation of the filler material 12 is initiated before heating of the filler material 12 is initiated, or the electromagnetic levitation and the heating of the filler material 12 are initiated simultaneously. For example, in some embodiments, the filler material 12 is electromagnetically levitated within a magnetic field and is also heated within the magnetic field. Specifically, the magnetic filed induced within the filler material 12 by the induction coil 20a may create circulating eddy currents in the filler material 12 that heat the filler material 12. In other embodiments, the filler material 12 is not electromagnetically levitated until after heating of the filler material 12 has been initiated. In some embodiments, the filler material 12 is electromagnetically levitated as soon as the filler material 12 is loaded into the melting chamber 26.

In such embodiments wherein the filler material 12 is not electromagnetically levitated until after heating of the filler material 12 has been initiated, electromagnetic levitation may be initiated as soon as any filler material 12 has transformed into a molten state to hold such molten filler material 12 within the melting chamber 26. For example, if a gate, plug, valve, and/or other flow control device is not provided within the outlet system 44, the electromagnetic levitation may be initiated as soon as any filler material 12 has transformed into a molten state to hold such molten filler material 12 within the melting chamber 26. In embodiments wherein a gate, plug, valve, and/or other flow control device is provided within the outlet system 44, the gate, plug, valve, and/or other flow control device may be relied upon to hold any molten filler material 12 within the inciting chamber 26 before the electromagnetic levitation is initiated, or the electromagnetic levitation may be initiated as soon as any filler material 12 has transformed into a molten state to supplement the gate, plug, valve, and/or other flow control device. Moreover, when the filler material 12 is supplied to the melting chamber 26 in a size that is smaller than the opening 46 or that is smaller than the openings within a filter or screen (not shown) that is held within the opening 46, electromagnetic levitation may be initiated as soon as the filler material 12 is loaded into the melting chamber 26 (in addition or alternative to using a gate, plug, valve, and/or other flow control device).

In some embodiments, the filler material 12 is not electromagnetically levitated until after all of the filler material 12 has been transformed into a molten state. In such embodiments wherein the filler material 12 is not electromagnetically levitated until after all of the filler material 12 has been transformed into a molten state, a gate, plug, valve, and/or other flow control device may be provided within the outlet system 44 to hold the molten filler material 12 within the melting chamber 26 before the electromagnetic levitation is initiated.

In the exemplary embodiment of the system 10, the same induction coil 20a is used to both heat filler material 12 and electromagnetically levitate filler material 12 within the melting chamber 26. It should be appreciated that, in some embodiments, the induction coil 20a may be energized with the same energization scheme (e.g., supplied with the same voltage and the same current) to both heat and electromagnetically levitate filler material 12. It should also be appreciated that, in other embodiments, the induction coil 20a may be energized with a different energization scheme (e.g., supplied with a different voltage and/or a different current) when heating filler material 12 than when electromagnetically levitating filler material 12.

In some embodiments, the target site 18 of the substrate material 14 is pretreated before molten filler material 12 is delivered thereto. Pretreating the target site 18 of the substrate material 14 may be performed prior to, simultaneously with, or subsequent to (or combinations thereof) melting the filler material 12. Pretreating the target site 18 may include, but is not limited to, preheating the target site 18 to a preheat temperature that is above room temperature but is below the solidus and/or recrystallization temperature of the target site 18, cleaning (e.g., a surface of) the target site 18, excavating at least a portion of the substrate material 14 at the target site 18, and/or the like.

Cleaning the target site 18 of the substrate material 14 may allow for a relatively high quality bond between the substrate material 14 and the filler material 12. Cleaning the target site 18 may include, but is not limited to, cleaning the target site 18 of oxides, other non-metallic compounds, and/or the like. Cleaning the target site 18 may be performed using any method, means, cleaning agent, and/or the like, such as, but not limited to, by pickling, hydrogen cleaning, fluoride ion cleaning, and/or the like.

Excavating at least a portion of the substrate material 14 at the target site 18 may allow for the repair of a more geometric, consistent, and/or otherwise accessible target site 18. Moreover, excavation may provide a target site 18 having any geometric and/or non-geometric shape, for example to facilitate the subsequent addition of filler material 12. Excavation of at least a portion of the substrate material 14 at the target site 18 may be performed using any method, means, tool, and/or the like, such as, but not limited to, by grinding, cutting, shaving, drilling, sanding, and/or the like.

Preheating the target site 18 may, among other things, help prevent the premature cooling and/or solidification of molten filler material 12 as the molten filler material 12 is applied to the target site 18, reduce residual stress present at and/or around the target site 18, and/or the like. The preheating of the target site 18 may be accomplished by a variety of heating methods, such as, but not limited to, using an induction coil, a furnace, a laser and/or any other apparatus that is capable of providing energy and/or heat to the target site 18. In some embodiments, the same heating element 20 used to melt the filler material 12 within the crucible 22 is also used to preheat the target site 18 of the substrate material 14. For example, a common induction coil (not shown) may transition between the target site 18 and the crucible 22 so long as the target site 18 does not rise above, but is instead maintained below, the solidus and/or recrystallization temperature of the target site 18 prior to the delivery of molten filler material 12 thereto.

In some embodiments, the temperature of the target site 18 of the substrate material 14 is monitored (e.g., using the controller 90 and/or another control system) via one or more temperature sensors (not shown) such as, but not limited to, thermocouples, pyrometers, thermometers and/or the like. Feedback from the one or more temperature sensors may be utilized to control the amount of heat and/or energy applied to the target site 18 of the substrate material 14 such that the preheat temperature is controlled. For example, such feedback can be utilized to control the amount of power to the preheating device, the distance between the preheating device and the target site 18, and/or any other variable that may affect the temperature of the target site 18 of the substrate material 14.

Once it is desired to begin applying molten filler material 12 to the substrate material 14, the flow control mechanism 74 is used to release molten filler material 12 from the crucible 22 through the outlet system 44. For example, in some embodiments, the electromagnetic levitation is at least partially released from the molten filler material 12 (e.g., by at least partially de-energizing the induction coil 20a), which enables gravitational forces acting on the molten filler material 12 to pull the molten filler material 12 through the outlet system 44. Any gates, plugs, valves, or other flow control devices provided within the outlet system 44 may be removed and/or opened to enable the molten filler material 12 to exit the outlet system 44 once the electromagnetic levitation has been at least partially released. In some embodiments, the flow control mechanism 74 is configured to release molten filler material 12 from the melting chamber 26 in a continuous molten stream.

In addition or alternative to at least partially releasing the electromagnetic levitation, in some embodiments, the flow control mechanism 74 may inject an inert gas (e.g., using the inlet system 32) into the melting chamber 26 at a pressure that ejects the molten filler material 12 from the melting chamber 26 through the outlet system 44. For example, the inert gas may have a pressure that exerts an ejection force on the filler material 12 that is greater than the holding force of the electromagnetic levitation. Moreover, and for example, the inert gas may have a pressure that exerts an ejection force on the filler material 12 that is greater than the holding force that remains once the electromagnetic levitation has been partially released. Further, and for example, the pressure of the inert gas may be used to supplement the gravitational forces that act on the molten filler material 12 after a complete release of the electromagnetic levitation. The pressure of the inert gas may be selected to deliver molten filler material 12 to the target site 18 of the substrate material 14 at any desired flow rate. The overall system response time for ejection of molten filler material 12 may be limited by the rate of rise of flow velocity during the transition to the steady state.

FIG. 5 illustrates molten filler material 12 being delivered from the melting chamber 26 of the crucible 22 to the target site 18 of the substrate material 14 through the outlet system 44. Referring now solely to FIG. 5, the molten filler material 12 may exit the outlet system 44 (e.g., the nozzle 50) at any flow distance D_{F} away from the target site 18 of the substrate material 14. The molten filler material 12 may be delivered and applied to the target site 18 of the substrate material 14 for any length of time, for example a length of time necessary to apply a desired and/or necessary amount of molten filler material 12 to the target site 18. For example, the duration of delivery and application of the molten filler material 12 to the target site 18 may depend on, but is not limited to depending on, the flow rate of the molten filler material 12, the size of the target site 18, and/or the like. Additionally, when the filler material 12 is melted in a specific environment (e.g., inert atmosphere, vacuum, and/or the like), the delivery and application of molten filler material 12 to the target site 18 may occur in the same or a substantially similar environment. The amount of mass and heat input from each delivery of molten filler material 12 to one or more target sites 18 may be controlled by presetting a pressure dwell as needed, such as, but not limited to, from approximately 0.05 to approximately 1 second.

In some embodiments, delivering the molten filler material 12 to the target site 18 of the substrate material 14 causes a local portion of the substrate material 14 (i.e., a portion of the substrate material 14 that comes into contact with the molten filler material 12) at the target site 18 to temporarily melt. Specifically, the temperature of the molten filler material 12 temporarily raises the temperature of the local portion of the substrate material 14 above the melting temperature of the local portion of the substrate material such that the molten filler material 12 and the local portion of the substrate material 14 bond together as the filler material 12 and the local portion of the substrate material 14 cool. In such embodiments, the resulting joint of the filler material 12 bonded with the substrate material 14 may be larger than an original gap.

In some embodiments, the outlet system 44 is configured to deliver molten filler material 12 from the crucible 22 to the target site 18 of the substrate material 14 in a continuous molten stream (e.g., without forming distinct droplets or other interruptions between deliveries). For example, the flow distance D_{F} and the flow rate of the molten filler material 12 may be coordinated such that the molten filler material 12 is delivered to the target site 18 in a continuous stream. Delivery of the molten filler material 12 in a continuous stream may refer to continuously applying the molten filler material 12 to the target site 18 without stoppage or breaks. By applying all of the molten filler material 12 to the target site 18 in a continuous stream (as opposed to in a plurality of application intervals with breaks between each application), the new material (i.e., the filler material 12) applied to the substrate material 14 may be capable of providing relatively strong mechanical properties post solidification. Moreover, depending on the particular filler material 12 used (e.g., Renè™ 142), the new material applied to the substrate material 14 may be capable of providing relatively stronger mechanical properties than what could be used if the filler material 12 was melted directly at the target site 18. Solidification of the molten filler material 12 may thereby occur through heat extraction into the cooler substrate material 14. In some embodiments, the system 10 is configured to deliver a continuous molten stream of filler material 12 that is greater than approximately 10 cm, greater than approximately 19 cm, approximately 20 cm, between approximately 10 cm and approximately 20 cm, and/or the like.

Once the desired amount of filler material 12 has been applied to the target site 18 of the substrate material 14, the delivery of molten filler material 12 to the target site 18 may be stopped by: re-applying the electromagnetically levitation to the filler material 12; by closing a gate, plug, valve, or other flow control device; by running out of molten filler material 12 within the crucible 22; and/or by moving the outlet system 44 away from the target site 18 of the substrate material 14. When it is desired to apply filler material 12 to another target site (not shown) of the substrate material 14 or to another substrate material (not shown, e.g., another component that is desired to be repaired using the filler material 12 and/or to otherwise have filler material 12 joined thereto), the electromagnetically levitation and/or the gate, plug, valve, or other flow control device may prevent filler material 12 from exiting (e.g., dribbling, flowing, and/or the like) the outlet system 44 as the outlet system 44 is moved to the other target site or the other substrate material. Once the outlet system 44 is positioned at the other target site or at the target site of the other substrate material, the flow control mechanism 74 can be actuated to release molten filler material 12 from the crucible 22 through the outlet system 44 as is described above.

FIG. 6 is a flowchart illustrating an exemplary embodiment of a method 300 for joining a filler material (e.g., the filler material 12 shown in FIGS. 1 and 5) to a substrate material (e.g., the substrate material 14 shown in FIG. 5). The method 300 may be perfoiined, for example, using the system 10 (FIGS. 1 and 5). At 302, the method 300 includes melting the filler material within a melting chamber (e.g., the melting chamber 26 shown in FIGS. 1 and 5) of a crucible (e.g., the crucible 22 shown in FIGS. 1 and 5) such that the filler material is completely molten. In some embodiments, melting the filler material at 302 includes melting the filler material using induction heating. Moreover, in some embodiments, the filler material is superheated by 200° C. or greater. Melting the filler material at 302 may include melting the filler material at a remote distance away from a target site of the substrate material such that melting at 302 the filler material maintains the target site of the substrate material below a solidus temperature and/or a recrystallization temperature of the target site. Moreover, melting the filler material at 302 may include applying a vacuum or an inert gas to the melting chamber.

At 304, the method 300 includes holding the filler material within the melting chamber of the crucible by electromagnetically levitating the filler material within the melting chamber. Holding the filler material at 304 prevents the filler material from exiting an outlet system (e.g., the outlet system 44 shown in FIGS. 1 and 5) of the crucible using the electromagnetic levitation. In some embodiments, electromagnetically levitating the filler material includes generating a first magnetic field from a coil (e.g., the induction coil 20a shown in FIGS. 1 and 5) that extends around the melting chamber to induce a second magnetic field within the filler material that is opposite the first magnetic field, wherein the opposite first and second magnetic fields hold the filler material within the melting chamber of the crucible. Moreover, in some embodiments, holding the filler material at 304 includes levitating the filler material in a magnetic field, and melting the filler material at 302 includes heating the filler material within the magnetic field.

At 306, the method 300 includes releasing the molten filler material from the melting chamber of the crucible to deliver the molten filler material to the target site of the substrate material. In some embodiments, relating the molten filler material at 306 includes delivering the filler material to the target site of the substrate material in a continuous molten stream, as is described above. Releasing the filler element at 306 enables the molten filler material to exit the outlet system of the crucible. In some embodiments, releasing the molten filler material at 306 includes at least partially releasing, at 306a, the electromagnetic levitation from the filler material. Moreover, in some embodiments, releasing the molten filler material at 306 includes ejecting, at 306b, the molten filler material from the melting chamber by injecting a gas into the melting chamber.

The method 300 may include repairing, at 308, the substrate material at the target site using the molten filler material, and/or joining, at 310, the substrate material to another component at the target site using the molten filler material.

Referring again to FIGS. 1 and 5, in some embodiments, the system 10 is: (1) thermal shock resistant to a rapid heating from room temperature to at least approximately 1550° C. within at least approximately 15 min; (2) capable of holding filler material 12 at at least approximately 1550° C. for at least approximately 30 min; (3) chemically inert when exposed to filler materials 12 at at least approximately 1550° C. for at least approximately 30 min; (4) capable of delivering a continuous molten stream of filler material 12 that is at least approximately 10 cm (e.g., up to approximately 20 cm) without breakup; (5) capable of delivering a stream of molten filler material 12 with less than approximately 50° C. temperature loss; and/or (6) capable of delivering streams of molten filler material 12 consecutively and/or consistently.

It should be noted that the various embodiments may be implemented in hardware, software or a combination thereof. The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a solid state drive, optical drive, and the like. The storage device may also be other similar means for loading computer programs or other instructions into the computer or processor.

As used herein, the term “computer”, “controller”, and “module” may each include any processor-based or microprocessor-based system including systems using microcontrollers, reduced instruction set computers (RISC), application specific integrated circuits (ASICs), logic circuits, GPUs, FPGAs, and any other circuit or processor capable of executing the functions described herein. The above examples are exemplary only, and are thus not intended to limit in any way the definition and/or meaning of the term “module” or “computer”.

The computer, module, or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer, module, or processor as a processing machine to perform specific operations such as the methods and processes of the various embodiments described and/or illustrated herein. The set of instructions may be in the form of a software program. The software may be in various forms such as system software or application software and which may be embodied as a tangible and non-transitory computer readable medium. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program. The individual components of the various embodiments may be virtualized and hosted by a cloud type computational environment, for example to allow for dynamic allocation of computational power, without requiring the user concerning the location, configuration, and/or specific hardware of the computer system.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. Dimensions, types of materials and/or substances, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the various embodiments described and/or illustrated herein should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments, including the best mode, and also to enable any person skilled in the art to practice the various embodiments described and/or illustrated herein, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. A method for joining a filler material to a substrate material, the method comprising:
melting the filler material within a melting chamber of a crucible such that the filler material is molten;
holding the filler material within the melting chamber of the crucible by electromagnetically levitating the filler material within the melting chamber; and
releasing the filler material from the melting chamber of the crucible to deliver the filler material to a target site of the substrate material.

2. The method of claim 1, wherein holding the filler material within the melting chamber of the crucible by electromagnetically levitating the filler material comprises preventing the filler material from exiting an outlet of the crucible using the electromagnetic levitation, and wherein releasing the filler material from the melting chamber comprises enabling the filler material to exit the outlet.

3. The method of claim 1, wherein releasing the filler material from the melting chamber of the crucible comprises releasing the electromagnetic levitation from the filler material.

4. The method of claim 1, wherein releasing the filler material from the melting chamber of the crucible comprises ejecting the filler material from the melting chamber by injecting a gas into the melting chamber.

5. The method of claim 1, wherein holding the filler material within the melting chamber of the crucible by electromagnetically levitating the filler material comprises generating a magnetic field from a coil that extends around the melting chamber, and wherein the magnetic field generated from the coil induces an opposite magnetic field within the filler material.

6. The method of claim 1, wherein holding the filler material within the melting chamber of the crucible by electromagnetically levitating the filler material comprises generating a magnetic field from a coil that extends around the melting chamber, the magnetic field having a vertical gradient along a height of the coil.

7. The method of claim 1, wherein holding the filler material within the melting chamber of the crucible by electromagnetically levitating the filler material comprises generating a magnetic field from a coil that extends around the melting chamber, the coil having an upper coil segment and a lower coil segment, wherein a turn of the upper coil segment is reversed relative to a turn of the lower coil segment.

8. The method of claim 1, wherein holding the filler material within the melting chamber of the crucible by electromagnetically levitating the filler material comprises generating a magnetic field from a coil that extends around the melting chamber, the coil having at least one of a conical shape or a cylindrical shape.

9. The method of claim 1, wherein melting the filler material within the melting chamber of the crucible comprises melting the filler material using induction heating.

10. The method of claim 1, wherein holding the filler material within the melting chamber of the crucible comprises levitating the filler material in a magnetic field, and wherein melting the filler material within the melting chamber of the crucible comprises heating the filler material within the magnetic field.

11. The method of claim 1, wherein melting the filler material within the melting chamber of the crucible comprises at least one of applying a vacuum to the melting chamber, injecting an inert gas to the melting chamber, or melting the filler material in a non-oxidizing environment.

12. The method of claim 1, wherein melting the filler material within the melting chamber of the crucible comprises melting the filler material at a remote distance away from the target site of the substrate material such that melting the filler material maintains the target site of the substrate material below at least one of a solidus temperature or a recrystallization temperature of the target site.

13. The method of claim 1, further comprising at least one of:
repairing the substrate material at the target site using the filler material; or
joining the substrate material to another component at the target site using the filler material.

14. A system for joining a filler material to a substrate material, the system comprising:
a crucible having a melting chamber for holding the filler material, the crucible comprising an outlet fluidly connected to the melting chamber;
a heating element operatively connected to the crucible for heating the filler material within the melting chamber of the crucible, the heating element being configured to melt the filler material within the melting chamber such that the filler material is molten; and
a flow control mechanism operatively connected to the crucible for controlling flow of the filler material through the outlet of the melting chamber, the flow control mechanism being configured to electromagnetically levitate the filler material within the melting chamber to hold the filler material within the melting chamber.

15. The system of claim 14, wherein the flow control mechanism is configured to prevent the filler material from exiting the outlet of the crucible by electromagnetically levitating the filler material within the melting chamber.

16. The system of claim 14, wherein the flow control mechanism is configured to release the electromagnetic levitation from the filler material to enable the filler material to exit the outlet.

17. The system of claim 14, wherein the flow control mechanism comprises a valve that is operatively connected to a supply of an inert gas, the valve being configured to inject the inert gas into the melting chamber to eject the filler material from the melting chamber through the outlet.

18. The system of claim 14, wherein the heating element comprises an induction coil that extends around the melting chamber of the crucible.

19. The system of claim 14, wherein the flow control mechanism comprises a coil that extends around the melting chamber of the crucible, the coil being configured to electromagnetically levitate the filler element within the melting chamber.

20. The system of claim 14, wherein the heating element comprises a coil that extends around the melting chamber of the crucible, the coil being configured to melt the filler material within the melting chamber, the flow control mechanism comprising the coil, the coil being configured to electromagnetically levitate the filler material within the melting chamber.

21. The system of claim 14, wherein the flow control mechanism comprises a coil that extends around the melting chamber of the crucible, the coil being configured to electromagnetically levitate the filler material within the melting chamber, the coil comprising an upper coil segment and a lower coil segment, wherein a turn of the upper coil segment is reversed relative to a turn of the lower coil segment.

22. The system of claim 14, wherein the flow control mechanism comprises a coil that extends around the melting chamber of the crucible, the coil being configured to electromagnetically levitate the filler material within the melting chamber, the coil comprising at least one of a conical shape or a cylindrical shape.

23. A method for joining a filler material to a substrate material, the method comprising:
providing a molten metal filler material within a melting chamber of a crucible;
generating a first magnetic field from a coil that extends around the melting chamber to induce a second magnetic field within the filler material that is opposite the first magnetic field, wherein the opposite first and second magnetic fields hold the filler material within the melting chamber of the crucible; and
releasing the filler material from the melting chamber of the crucible to deliver the filler material to a target site of the substrate material.
